(19) United States
(12) Patent Application Publication
(10) Pub. No.: US 2010/0172452 A1
(43) Pub. Date: Jul. 8, 2010

(54) OFDMA RECEPTION DEVICE AND OFDMA RECEPTION METHOD

(75) Inventor: Kazuyuki Tota, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/601,225

(22) PCT Filed: May 1, 2008
(86) PCT No.: PCT/JP2008/058334

§ 371 Date: Mar. 18, 2010

(30) Foreign Application Priority Data
May 21, 2007 (JP) 2007-134005

(51) Int. Cl. H04L 27/08

(52) U.S. Cl. 375/345

(57) ABSTRACT

A base station (12) which communicates with mobile stations according to an OFDMA system includes: a reception gain determination unit (42) for determining a gain with respect to received signals; an AGC amplifier (24) for controlling reception levels of the received signals according to the gain determined by the reception gain determination unit (42); an RSSI detection unit (32) for detecting, for each of subchannels, an RSSI indicating the reception level controlled by the AGC amplifier (24); and an RSSI judgment unit (40) for obtaining, for each of the subchannels, a demodulatable range indicating a range of a reception level required for demodulating the received signals, and judging whether or not each of the RSSIs detected by the RSSI detection unit (32) is within the demodulatable range. The reception gain determination unit (42) determines the gain, based on a maximum RSSI of the RSSIs detected by the RSSI detection unit (32) and on the demodulatable range of a subchannel for which the maximum RSSI is detected.

### TECHNICAL FIELD

The present invention relates to an OFDMA reception device and an OFDMA reception method, and more particularly, to a technology of controlling reception levels of received signals by OFDMA.

### BACKGROUND ART

In a radio reception device, only a received signal with a reception level that falls within a dynamic range determined based on a reception circuit structure thereof (hereinafter, referred to as “reception dynamic range”) is correctly demodulated. For this reason, some radio reception devices control the reception level for each channel so that the reception level may be maintained within the reception dynamic range.

In this regard, in the orthogonal frequency division multiple access (OFDMA), in which communications are performed by using a plurality of subchannels within a predetermined frequency band, the number of subcarriers constituting one subchannel and the frequencies thereof are variable. Accordingly, it is difficult to apply an analog filter to each subchannel. Therefore, the reception level may not be controlled for each subchannel in automatic gain control (AGC), and hence the reception levels are uniformly changed throughout the reception frequency band, which may lead to a case where a subchannel that has been capable of communications is rendered incapable of communications due to the AGC.

FIG. 7 are diagrams illustrating reception levels of radio signals at a base station, which are transmitted from each of three mobile stations (PS#A to PS#C). There is assumed a case where, as illustrated in FIG. 7(A), the reception level of the mobile station PS#C exceeds the reception dynamic range of the base station while the reception level of the mobile station PS#A falls within the reception dynamic range. In this case, if the AGC is applied with respect to the received signals in order that the reception level of the mobile station PS#C falls within the reception dynamic range, the reception level is uniformly lowered across the entire reception frequency band as illustrated in FIG. 7(B), which may lead to a case where the reception level of the mobile station PS#A, which has been within the reception dynamic range, falls below the reception dynamic range.

In order to solve the above-mentioned problems, there has been conventionally adopted transmission power control in which a transmission level of a transmission signal is controlled for each of subchannels or subcarriers, to thereby control a reception level of each of the subchannels (see, for example, Patent Document 1). Patent Document 1: JP 2000-332723 A

### DISCLOSURE OF THE INVENTION

### Problems to be Solved by the Invention

However, according to the above-mentioned conventional transmission power control, there has been a problem in that there is a limit on a transmission level increase of a transmission signal, whereas if the transmission level is lowered, a sufficient carrier to noise ratio (CNR) may not be attained during transmission.

The present invention has been made in view of the above-mentioned problems inherent in the related art, and therefore it is an object of the invention is to provide an OFDMA reception device and an OFDMA reception method capable of suitably controlling, not through transmission power control, reception levels of received signals by OFDMA.

### Means for Solving the Problems

In order to solve the above-mentioned problems, the present invention provides an OFDMA reception device which receives signals transmitted from each of a plurality of communications devices by using a plurality of subchannels according to an orthogonal frequency division multiple access system, including: reception gain determination means for determining a gain with respect to the received signals; reception level control means for controlling reception levels of the received signals, according to the gain determined by the reception gain determination means; reception level detection means for detecting, for each of the plurality of subchannels, the reception level controlled by the reception level control means; and reception level judgment means for obtaining, for each of the plurality of subchannels, a demodulatable range which corresponds to a range of a reception level required for demodulating the received signals, and judging whether or not each of the reception levels detected by the reception level detection means falls within the demodulatable range, in which the reception gain determination means determines the gain, based on a maximum reception level of the reception levels detected by the reception level detection means and on the demodulatable range of a subchannel for which the maximum reception level is detected.

According to the present invention, the demodulatable range is obtained for each of the subchannels by OFDMA. Further, of the subchannels for which the reception levels are detected, a subchannel having a maximum reception level is used as a reference to control a gain for the received signals such that the reception level falls within the demodulatable range (preferably, in the vicinity of an upper limit value of the demodulatable range). Accordingly, communications via a subchannel which is high in reception level (high in CNR) is preferentially sustained. Further, based on a reception level obtained after the gain control and a demodulatable range, the received signal is determined as to whether the demodulation thereof is possible or not for each subchannel. In this manner, according to the present invention, it is possible to suitably control, not through transmission power control, reception levels of received signals by OFDMA. Note that it is not possible to continue communications via a subchannel which has a reception level falling below a lower limit value of the demodulatable range due to the gain control, and hence a channel switching process, such as hand-over, is performed.

Further, in an aspect of the present invention, the reception gain determination means determines the gain so that the maximum reception level becomes equal to an upper limit value of the demodulatable range of the subchannel for which the maximum reception level is detected. According to this aspect, a reception level of each subchannel is amplified within each demodulatable range thereof, with reference to the subchannel having the maximum reception level, which makes it possible to attain high-throughput communications.

Further, in an aspect of the present invention, the reception level judgment means obtains the demodulatable range of each of the plurality of subchannels, based on a reception dynamic range of the OFDMA reception device and on a modulation scheme of each of the plurality of subchannels. According to this aspect, the demodulatable range is determined based on a reception dynamic range which is determined based on a reception circuit structure and on a required reception quality (for example, a required CNR) according to a modulation scheme of each subchannel. Accordingly, in a subchannel adopting a modulation scheme which is low in required reception quality (low in symbol rate), a lower limit value of the demodulatable range is lowered, which makes it easier than heretofore to sustain communications through a signal which is low in reception level (low in CNR).

In this aspect, the OFDMA reception device may further include modulation scheme changing means for changing a modulation scheme of a subchannel with a reception level detected, by the reception level detection means, as being lower than a lower limit value of the demodulatable range to a modulation scheme which is lower in required reception quality (lower in symbol rate) so that the reception level falls within the demodulatable range. With this configuration, it becomes easier to sustain communications even via a subchannel low in reception level, which reduces, for example, frequency of initiating hand-over.

Further, in an aspect of the present invention, the reception dynamic range corresponds to a dynamic range of an A/D converter included in the OFDMA reception device.

The present invention also provides an OFDMA reception method for receiving signals transmitted from each of a plurality of communications devices by using a plurality of subchannels according to an orthogonal frequency division multiple access system, including: a reception level detection step of detecting reception levels of the signals received via each of the plurality of subchannels; a demodulatable range acquisition step of obtaining a demodulatable range for each of the plurality of subchannels, the demodulatable range corresponding to a range of a reception level required for demodulating the received signals; a reception gain control step of controlling a gain with respect to the received signals, based on a maximum reception level of the reception levels detected in the reception level detection step and on the demodulatable range of a subchannel for which the maximum reception level is detected; and a reception level judgment step of judging whether or not each of the reception levels detected in the reception level detection step falls within the demodulatable range.

### BRIEF DESCRIPTION OF THE DRAWINGS

FIG. 1 is a diagram illustrating an entire configuration of a mobile communication system according to an embodiment of the present invention.

FIG. 2 is a block diagram for illustrating a reception function of abase station according to the embodiment of the present invention.

FIG. 3 is a diagram illustrating an example of an RSSI threshold value table.

FIG. 4 is a graph illustrating required CNRs by modulation schemes.

FIG. 5 are diagrams illustrating demodulatable ranges each corresponding to 64 QAM and π/4 shift QPSK, respectively.

FIG. 6 is a flow chart illustrating in part a reception process in the base station.

FIG. 7 are diagrams illustrating reception levels of radio signals at a base station, which are transmitted from each of three mobile stations (PS#A to PS#C).

### BEST MODE FOR CARRYING OUT THE INVENTION

Hereinafter, an embodiment of the present invention is described in detail with reference to the accompanying drawings.

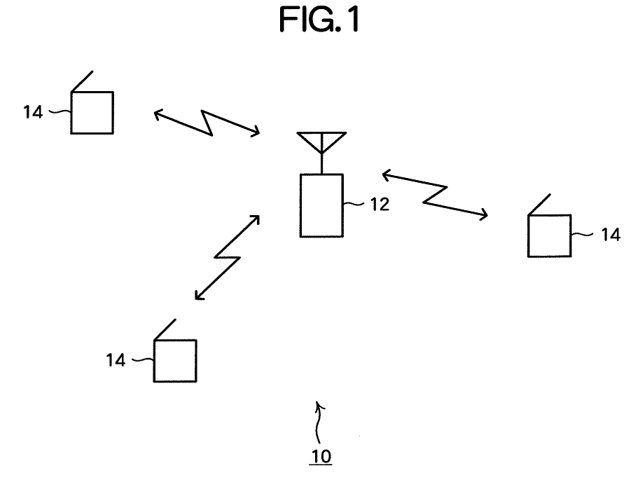

FIG. 1 is a diagram illustrating an entire configuration of a mobile communications system 10 according to the embodiment of the present invention. As illustrated in the drawing, the mobile communications system 10 includes abase station 12 and a plurality (three in this case) of mobile stations 14. The mobile station 14 may be, for example, a portable cellular phone, a personal digital assistant, or a data communications card.

The base station 12 transmits and receives a radio signal to and from each of the mobile stations 14 according to a time division duplex (TDD) system, and also performs multiplex communications according to an orthogonal frequency division multiple access (OFDMA) system and a time division multiple access (TDMA) system.

Hereinbelow, in regard to the reception of a radio signal, a configuration and functions provided to the base station 12 are described in further detail.

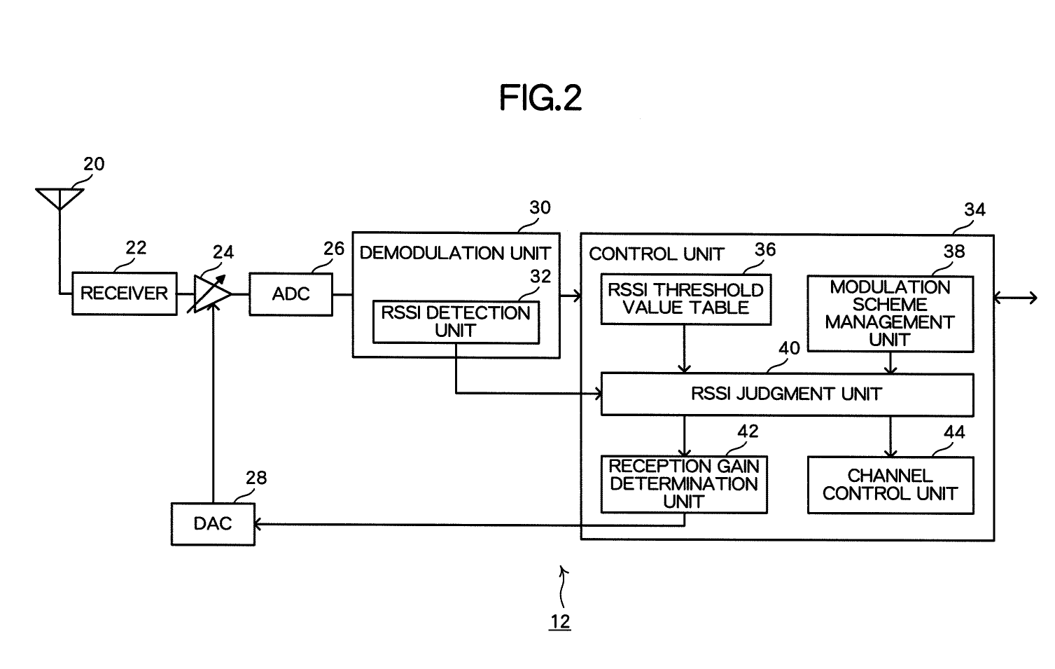

FIG. 2 is a block diagram for illustrating a reception function of the base station 12. As illustrated in FIG. 2, the base station 12 includes an antenna 20, a receiver 22, an AGC amplifier 24, an A/D converter (ADC) 26, a D/A converter (DAC) 28, a demodulation unit 30, and a control unit 34.

The antenna 20 receives a radio signal transmitted from the mobile station 14, and outputs the received radio signal to the receiver 22. The receiver 22 down-converts the radio signal received by the antenna 20 into a baseband signal. The baseband signal is further subjected to symbol synchronization and removal of the guard interval, and then output to the AGC amplifier 24 by the receiver 22.

The AGC amplifier 24 is a variable gain amplifier, which controls (amplifies or attenuates) the reception level of the baseband signal input from the receiver 22 according to a gain control voltage input from the DAC 28. The gain control voltage input from the DAC 28 corresponds to a voltage according to a gain determined by a reception gain determination unit 42, which is described later.

The ADC 26 converts the baseband signal which has been gain-controlled by the AGC amplifier 24 into a digital signal, and outputs the digital signal obtained through the conversion to the demodulation unit 30. It should be noted that a baseband signal that is successfully converted into a digital signal is limited to a signal which has a reception level falling within a dynamic range (a range of from a noise floor to a permissible input level) of the ADC 26. The dynamic range corresponds to a signal to noise ratio (SNR) determined according to an effective number of bits (ENOB) of the ADC 26. The dynamic range is determined as 72 dB when, for example, the effective number of bits of the ADC is 12 bits.

The demodulation unit 30 converts, through fast Fourier transform (FFT), the digital signal input from the ADC 26 into subcarrier components of complex symbols which represent a phase and an amplitude of each subcarrier. Then, the demodulation unit 30 converts, according to a modulation scheme of each subcarrier, the complex symbols into corresponding binary data, and outputs the binary data obtained by the conversion, to the control unit 34.

Further, the demodulation unit 30 includes an RSSI detection unit 32 for detecting, for each subchannel, a reception level which has been gain-controlled by the AGC amplifier 24. The RSSI detection unit 32 classifies, for each subchannel, the subcarrier components of complex symbols obtained through the above-mentioned FFT, and detects, from the complex symbols thus classified, a received signal strength indication (RSSI) which indicates a reception level of each subchannel.

The control unit 34 is configured by including a CPU, a memory, and the like, and controls each unit of the base station 12. Further, the control unit 34 includes an RSSI threshold value table 36, a modulation scheme management unit 38, an RSSI judgment unit 40, a reception gain determination unit 42, and a channel control unit 44, and performs such functions as a function of controlling the AGC amplifier 24 and a function of changing a modulation scheme. The CPU executes various control programs stored in the memory, to thereby implement those functions.

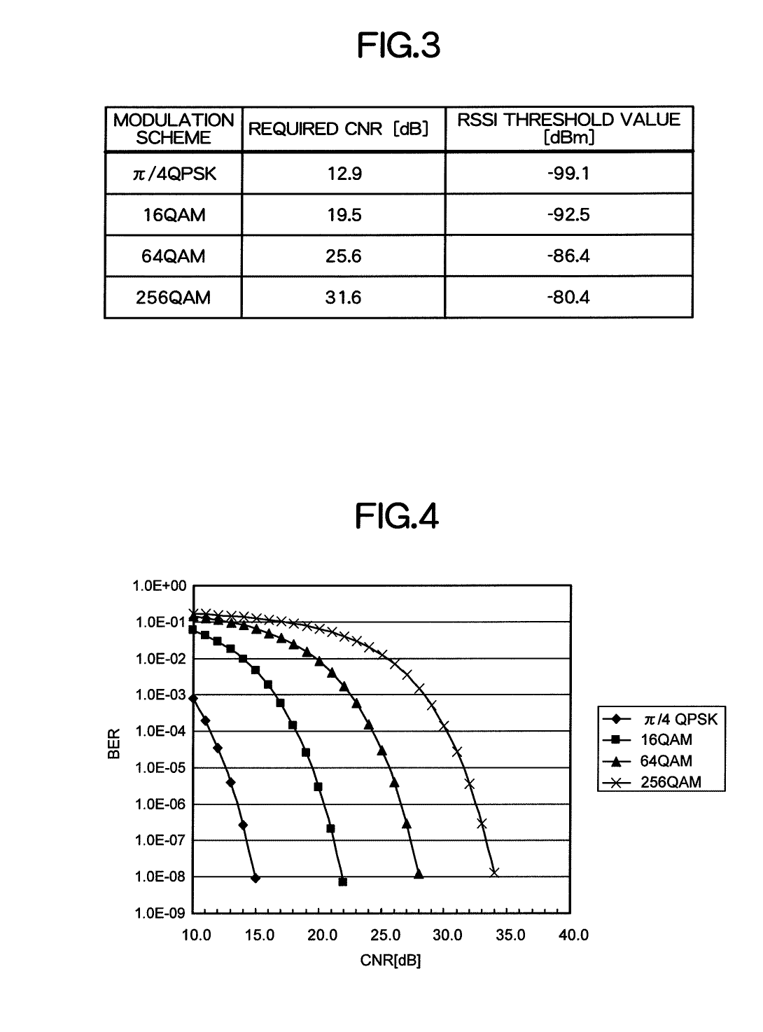

The RSSI threshold value table 36 stores, for each modulation scheme, a required CNR and a lower limit value (RSSI threshold value) of an RSSI required for demodulating a signal modulated using the corresponding modulation scheme. FIG. 3 is a diagram illustrating an example of the RSSI threshold value table 36. The required CNR of FIG. 3 is determined according to the modulation scheme and a desired bit error rate (BER). Further, the RSSI threshold value is determined based on the dynamic range of the ADC 26 and the required CNR according to the modulation scheme. Hereinbelow, a specific description is given of how to determine the RSSI threshold value.

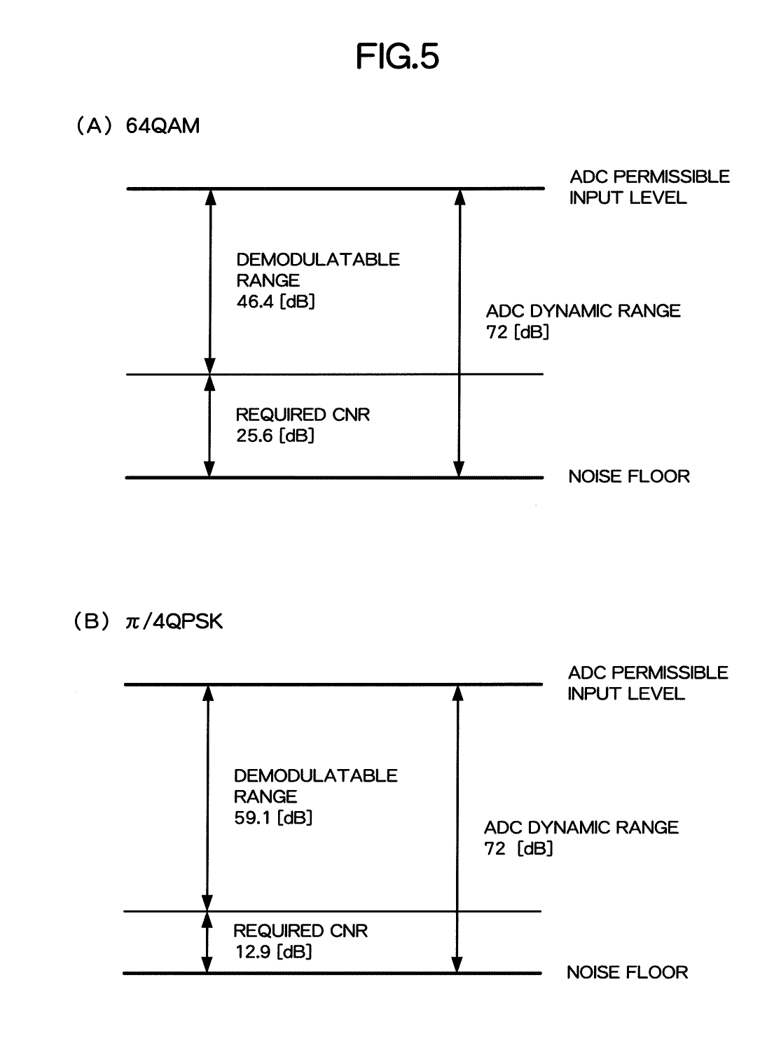

FIG. 4 is a graph illustrating the required CNRs by modulation schemes. As illustrated in FIG. 4, a modulation scheme which has a higher symbol rate requires a higher CNR to maintain a predetermined BER. Further, in any of the modulation schemes, a higher CNR is required in order to reduce the BER. For example, in 64 QAM, the CNR is required to be 25.6 dB to reduce the BER to 0.001%. This means that, in order to reduce the BER of a signal modulated using 64 QAM to 0.001% or less, the RSSI needs to be equal to or larger than 25.6 dB from the noise floor. On the other hand, in π/4 shift QPSK, the CNR of 12.9 dB is required for reducing the BER to 0.001%.

Further, as described above, in order to correctly demodulate the received signal, the RSSI is required to fall at least within the dynamic range of the ADC 26. In the block diagram illustrated in FIG. 2, assuming a case where a reception gain from the antenna 20 to the demodulation unit 30 is 40 dB and the dynamic range of the ADC 26 is 72 dB (effective number of bits is 12 bits), the range of RSSI (ADC usable range) in which ADC 26 may correctly perform digital conversion of a signal is −112 to −40 dBm in terms of input value of the antenna 20 (assuming that the input level at the antenna 20 is 0 dBm).

As described above, the demodulatable range, which corresponds to the range of RSSI required for demodulating a received signal, is from a level higher than the noise floor by a required CNR to a permissible input level of the ADC 26. In other words, each of the RSSI threshold values stored in the RSSI threshold value table 36 corresponds to a value obtained by adding a required CNR corresponding to each modulation scheme to the noise floor level.

FIG. 5 are diagrams illustrating demodulatable ranges each corresponding to 64 QAM in FIG. 5(A) and π/4 shift QPSK in FIG. 5(B), respectively, in a case where a reception gain from the antenna 20 to the demodulation unit 30 is 40 dB, a dynamic range of the ADC 26 is 72 dB, and a desired BER is 0.001%. As illustrated in FIG. 5(A), the demodulatable range corresponding to 64 QAM is 46.4 dB (−86.4 to −40 dBm in terms of input value of the antenna 20) which is obtained by subtracting a required CNR 25.6 dB from the dynamic range of 72 dB of the ADC 26, and the RSSI threshold value is determined as −86.4 dBm. Meanwhile, as illustrated in FIG. 5(B), the demodulatable range corresponding to π/4 shift QPSK is 59.1 dB (−99.1 to −40 dBm), and the RSSI threshold value is determined as −99.1 dBm. The RSSI threshold value for each of the other modulation schemes illustrated in FIG. 3 is determined in a similar manner.

The modulation scheme management unit 38 manages a modulation scheme applied to each of the subchannels, and notifies the RSSI judgment unit 40 of the modulation scheme for each of the subchannels, in response to a request from the RSSI judgment unit 40. Modulation schemes employed in the mobile communications system 10 according to this embodiment include π/4 shift QPSK, 16 QAM, 64 QAM, and 256 QAM.

The RSSI judgment unit 40 selects, from among the RSSIs of the subchannels detected by the RSSI detection unit 32, a maximum RSSI, and notifies the reception gain determination unit 42 of the maximum RSSI.

Further, the RSSI judgment unit 40 obtains the modulation schemes of the subchannels from the modulation scheme management unit 38, and obtains the RSSI threshold values according to the respective modulation schemes from the RSSI threshold value table 36. Then, the RSSI judgment unit 40 judges, for each subchannel, whether or not the RSSI detected by the RSSI detection unit 32 falls within the demodulatable range (or is equal to or larger than the RSSI threshold value and equal to or smaller than the permissible input level of the ADC 26). For a subchannel with an RSSI which falls below the RSSI threshold value, it is further judged, based on the RSSI threshold value table 36, whether or not there is any other suitable modulation scheme in which a required CNR is lower (a symbol rate is lower) and hence the RSSI thereof is allowed to fall within the demodulatable range. Then, the RSSI judgment unit 40 notifies the channel control unit 44 of the judgment result. That is, when a suitable modulation scheme is found, the RSSI judgment unit 40 notifies the modulation scheme and the subchannel, whereas when a suitable modulation scheme is not found, the RSSI judgment unit 40 notifies only the subchannel.

The reception gain determination unit 42 determines a gain for adjusting the RSSI of the baseband signal input from the receiver 22, based on the maximum RSSI notified by the RSSI judgment unit 40 and the permissible input level (the upper limit value of the demodulatable range) of the ADC 26. At this time, it is preferable that the gain is determined so that the maximum RSSI becomes equal to the permissible input level of the ADC 26. This way, the RSSI of each of the subchannels is amplified within the demodulatable range corresponding thereto, with reference to the subchannel having the maximum RSSI, which makes it possible to attain high-throughput communications. The gain thus determined is converted into a gain control voltage by the DAC 28, and then input to the AGC amplifier 24.

The channel control unit 44 changes, based on the judgment result notified by the RSSI judgment unit 40, the modulation scheme of the subchannel thus notified, or instructs the mobile station 14 which is assigned the subchannel to perform hand-over. In other words, in a case where a modulation scheme and a subchannel are notified by the RSSI judgment unit 40 (in a case where a suitable modulation scheme with lower symbol rate is found), the channel control unit 44 changes the modulation scheme of the corresponding subchannel to the notified modulation scheme, while in a case where only a subchannel is notified, the channel control unit 44 instructs the mobile station 14 which is assigned the subchannel to perform hand-over. This makes it easier to sustain communications even via a subchannel with a lower RSSI, which reduces frequency of initiating hand-over.

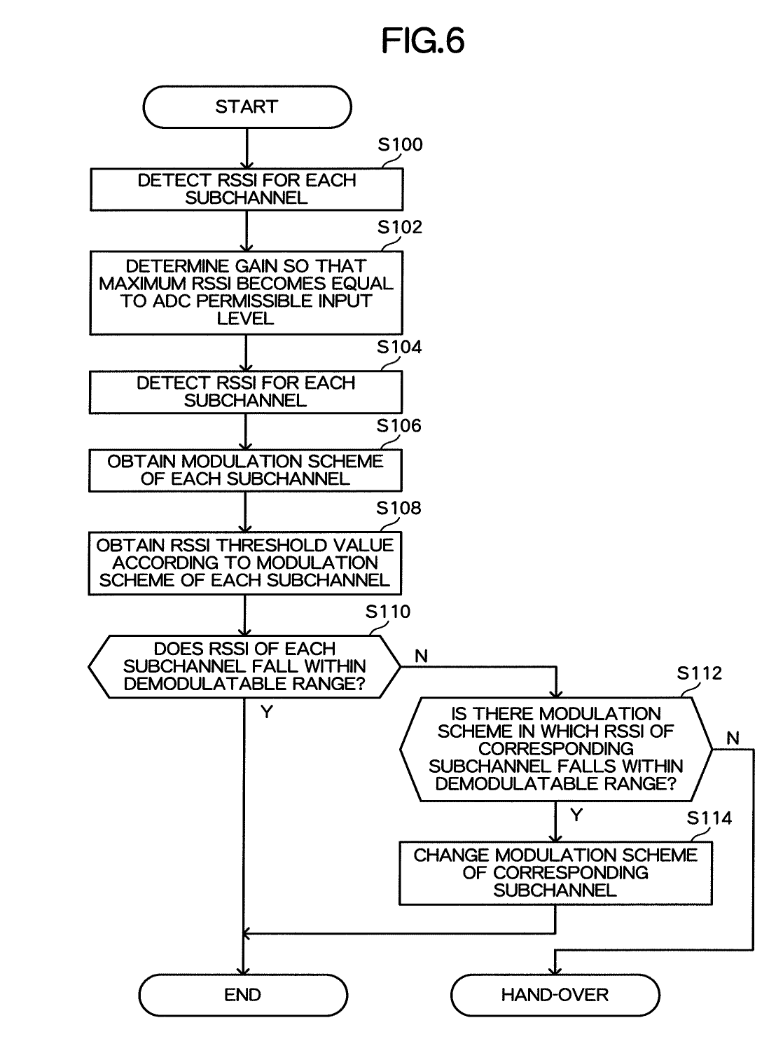

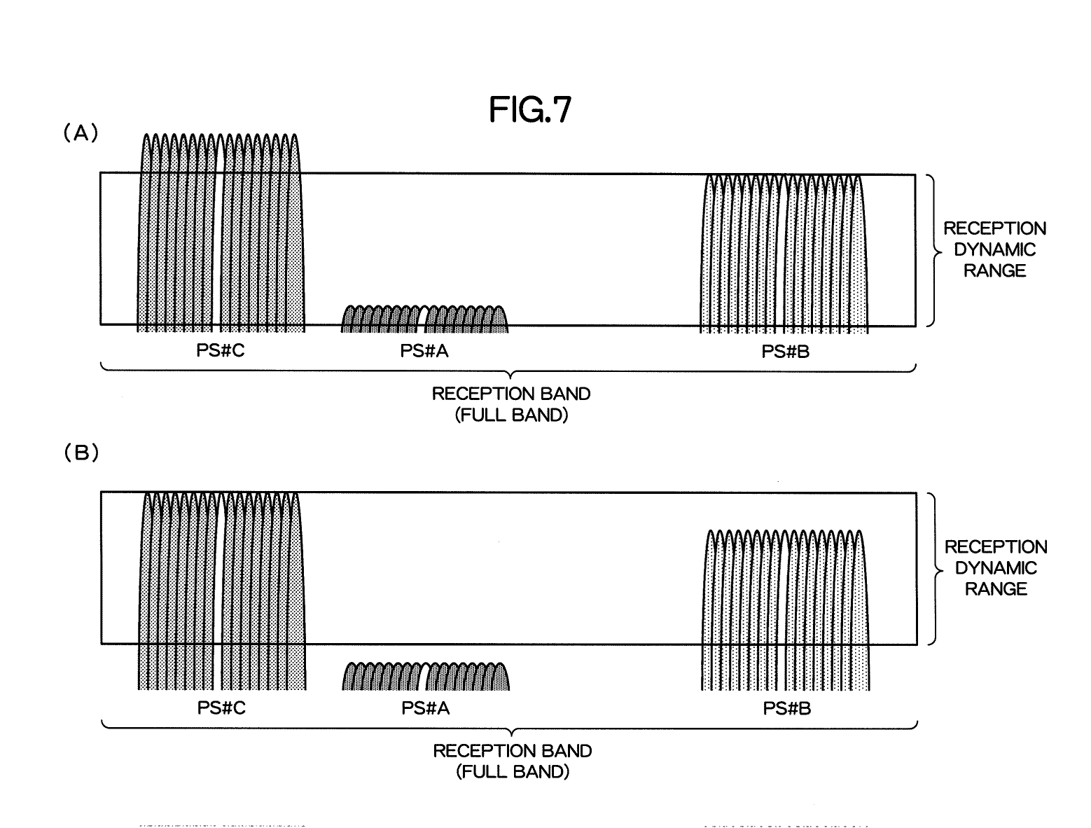

Next, a reception process in the base station 12 is described with reference to FIG. 6. FIG. 6 is a flow chart illustrating in part the reception process in the base station 12.

As illustrated in FIG. 6, upon reception of a radio signal, the RSSI detection unit 32 classifies the subcarrier components of complex symbols obtained through FFT for each subchannel, and detects the RSSIs of the respective subchannels (S100). Next, the reception gain determination unit 42 determines a gain such that a maximum RSSI of the RSSIs detected in S100 becomes equal to the permissible input level of ADC 26 (S102). In this manner, the AGC amplifier 24 controls the reception level of the baseband signal input from the receiver 22, according to the gain thus determined.

When the RSSI of the baseband signal which has been gain-controlled by the AGC amplifier 24 is detected by the RSSI detection unit 32 (S104), the RSSI judgment unit 40 obtains the modulation schemes of the respective subchannels from the modulation scheme management unit 38 (S106), and obtains the RSSI threshold values according to the modulation schemes of the respective subchannels, from the RSSI threshold value table 36 (S108). Then, the RSSI judgment unit 40 judges, for each subchannel, whether or not the RSSI detected in S104 falls within the demodulatable range (or is equal to or larger than the RSSI threshold value obtained in S108 and equal to or smaller than the permissible input level of the ADC 26) (S110). Here, with regard to a subchannel with an RSSI which falls within the demodulatable range, the process is directly ended.

On the other hand, for a subchannel which has been judged in 5110 that the RSSI falls out of the demodulatable range (falls below the RSSI threshold value), it is further judged, based on the RSSI threshold value table 36, whether or not there is any other suitable modulation scheme in which a required CNR is lower (a symbol rate is lower) and hence the RSSI thereof is allowed to fall within the demodulatable range (S112). Here, when a suitable modulation scheme is found, the channel control unit 44 changes the modulation scheme of the subchannel to the suitable modulation scheme (S114). On the other hand, in a case where a suitable modulation scheme is not found, the channel control unit 44 instructs the mobile station 14 which is assigned the subchannel to perform hand-over.

According to the mobile communications system 10 as described above, the reception levels of the received signals are controlled by the AGC amplifier 24 in the base station 12, and it is judged, for each subchannel, whether the demodulation of the signal is possible or not, according to the demodulatable range obtained based on the dynamic range of the ADC 26 and the modulation scheme of each of the subchannels. In this manner, it is possible to suitably control, not through the transmission power control in the mobile station 14, the reception levels of the received signals by OFDMA.

It should be noted that the present invention is not limited to the above-mentioned embodiment, and may be subjected to various modifications.

For example, in the above-mentioned embodiment, the present invention is applied to the mobile communications system which employs the OFDMA system and the TDMA/TDD system, but the present invention is generally applicable to any communications systems employing the OFDMA system.

Further, in the above-mentioned embodiment, the demodulatable range is determined based only on the dynamic range of the ADC 26 and the required CNR according to the modulation scheme, but the demodulatable range may be determined further based on another element constituting the reception circuit. It should be noted that, in the above-mentioned embodiment, all the subchannels employ the same upper limit value of the demodulatable range (the permissible input level of the ADC 26), but the present invention is also applicable to the OFDMA reception device in which the upper limit value of the demodulatable range is different for each subchannel.

Further, in the communications system in which the number of subcarriers forming one subchannel is different for each subchannel, the RSSI judgment unit 40 may perform selection of the maximum RSSI or threshold value judgment of RSSI, based on a mean RSSI which is obtained by dividing the RSSIs of the respective subchannels detected by the RSSI detection unit 32 by the number of subcarriers forming the respective subchannnels.

1. An OFDMA reception device which receives signals transmitted from each of a plurality of communications devices by using a plurality of subchannels according to an orthogonal frequency division multiple access system, comprising:
reception gain determination means for determining a gain with respect to the received signals;
reception level control means for controlling reception levels of the received signals, according to the gain determined by the reception gain determination means;
reception level detection means for detecting, for each of the plurality of subchannels, the reception level controlled by the reception level control means; and
reception level judgment means for obtaining, for each of the plurality of subchannels, a demodulatable range which corresponds to a range of a reception level required for demodulating the received signals, and judging whether or not each of the reception levels detected by the reception level detection means falls within the demodulatable range,
wherein the reception gain determination means determines the gain, based on a maximum reception level of the reception levels detected by the reception level detection means and on the demodulatable range of a subchannel for which the maximum reception level is detected.

2. An OFDMA reception device according to claim 1,
wherein the reception gain determination means determines the gain so that the maximum reception level becomes equal to an upper limit value of the demodulatable range of the subchannel for which the maximum reception level is detected.

3. An OFDMA reception device according to claim 1 or 2,
wherein the reception level judgment means obtains the demodulatable range of each of the plurality of subchannels, based on a reception dynamic range of the OFDMA reception device and on a modulation scheme of each of the plurality of subchannels.

4. An OFDMA reception device according to claim 3, further comprising modulation scheme changing means for changing a modulation scheme of a subchannel with a reception level detected, by the reception level detection means, as being lower than a lower limit value of the demodulatable range to a modulation scheme which is lower in required reception quality so that the reception level falls within the demodulatable range.

5. An OFDMA reception device according to claim 3,
wherein the reception dynamic range corresponds to a dynamic range of an A/D converter included in the OFDMA reception device.

6. An OFDMA reception method for receiving signals transmitted from each of a plurality of communications devices by using a plurality of subchannels according to an orthogonal frequency division multiple access system, comprising:
a reception level detection step of detecting reception levels of the signals received via each of the plurality of subchannels;
a demodulatable range acquisition step of obtaining a demodulatable range for each of the plurality of subchannels, the demodulatable range corresponding to a range of a reception level required for demodulating the received signals;
a reception gain control step of controlling a gain with respect to the received signals, based on a maximum reception level of the reception levels detected in the reception level detection step and on the demodulatable range of a subchannel for which the maximum reception level is detected; and
a reception level judgment step of judging whether or not each of the reception levels detected in the reception level detection step falls within the demodulatable range.
